(19) United States
(12) Patent Application Publication
(10) Pub. No.: US 2009/0034106 A1
(43) Pub. Date: Feb. 5, 2009

(54) COLOR WHEEL FOR USE IN PROJECTION DEVICE

(75) Inventors: YU-LUN HO, Tu-Cheng (TW); CHIH-WEI TSO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/950,389

(22) Filed: Dec. 4, 2007

(30) Foreign Application Priority Data
Aug. 3, 2007 (CN) 200710201268.1

(51) Int. Cl. G02B 7/00; G02B 5/22

(52) U.S. Cl. 359/892; 359/891

(57) ABSTRACT

An exemplary color wheel for use in DLP projectors includes a motor, a color filter unit, a locking member, and an elastic member. The motor includes a rotor portion. The rotor portion protrudes a shaft. The shaft defines a receiving portion therein. The color filter unit defines a through hole for extension of the shaft. The locking member is slidably engaged with the receiving portion to fix the color filter unit to the rotor portion. The elastic member is interposed between the color filter unit and the locking member.

### BACKGROUND

1. Technical Field

The present invention relates to color wheels and, particularly, relates to a color wheel for use in projection device.

2. Description of Related Art

Color wheels are commonly used as a sequential dispersing device in digital light processing (DLP) projectors to disperse white light into red (R), green (G) and blue (B) light, and in cooperation with a digital micro-mirror device (DMD) project a color image. Such a color wheel typically includes a disk-shaped color filter unit that commonly includes a rigid and frangible substrate, and a motor for driving the color filter unit to rotate. Conventionally, the assembly of the color filter unit and the motor is maintained using hot-curable adhesive, resulting in: (1) the motor may be easily damaged in a curing process to cure the hot-curable adhesive; and (2) reworkablity of the color wheel is less than optimal because the assembled components (i.e., color filter unit and motor) are inseparable, so, a workable component in a partially damaged color wheel cannot be reused.

In order to overcome the abovementioned problems, a color wheel maintaining the assembly of the color filter unit and the motor using mechanical force is proposed. Whereas, new challenges appear, for example, the mechanical force applied to the color filter unit may damage the rigid and frangible substrate of the color filter unit.

Therefore, it is desirable to provide a color wheel for use in projection device, which can overcome the above-mentioned problems.

### SUMMARY

In a present embodiment, a color wheel for use in DLP projectors includes a motor, a color filter unit, a locking member, and an elastic member. The motor includes a rotor portion. The rotor portion protrudes a shaft. The shaft defines a receiving portion therein. The color filter unit defines a through hole that is fittingly inserted through by the shaft. The locking member is slidably locked in the receiving portion to fix the color filter unit to the rotor portion. The elastic member is interposed between the color filter unit and the locking member.

### BRIEF DESCRIPTION OF THE DRAWINGS

Many aspects of the present color wheel should be better understood with reference to the following drawings. The components in the drawings are not necessarily drawn to scale, the emphasis instead being placed upon clearly illustrating the principles of the present color wheel. Moreover, in the drawings, like reference numerals designate corresponding parts throughout the several views.

FIG. 1 is an isometric, exploded view of a color wheel including an elastic member, according to a first embodiment.

FIG. 2 is a planar, assembled view of the color wheel of FIG. 1.

FIG. 3 is a schematic, cross-sectional view showing an alternative elastic member of FIG. 1.

FIG. 4 is a schematic, cross-sectional view showing another alternative elastic member of FIG. 1

FIG. 5 is a planar, assembled view of a color wheel, according to a second embodiment.

### DETAILED DESCRIPTION OF THE EMBODIMENTS

Embodiments of the present color wheel will be now described in detail with reference to the drawings.

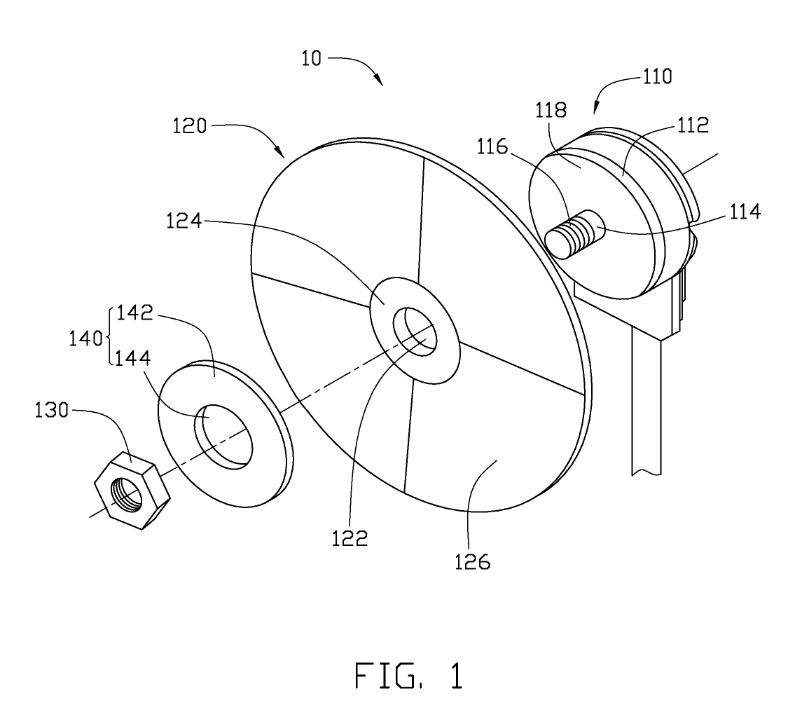

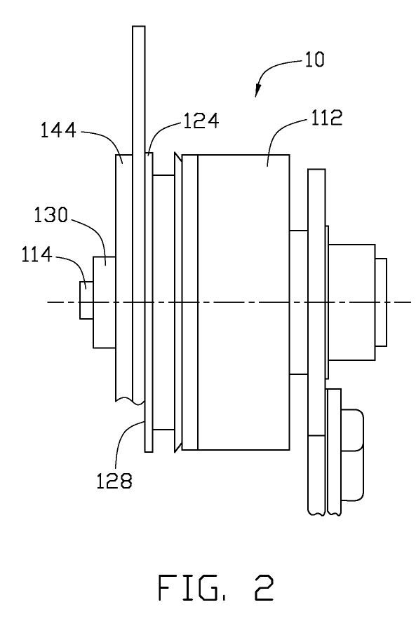

Referring to FIGS. 1, 2, a color wheel 10 for use in DLP projectors, according to a first embodiment, includes a motor 110, a color filter unit 120, a locking member 130, and an elastic member 140. The motor 110 includes a rotor portion 112. The rotor portion 112 protrudes a shaft 114. The shaft 114 defines a receiving portion 116 therein, near the distal end thereof. The color filter unit 120 defines a first through hole 122 for extension of the shaft 114 therethrough. The locking member 130 is accommodated and slidably engaged with the receiving portion 116 to fix the color filter unit 120 to the rotor portion 112. In particular, the receiving portion 116 is a threaded section defined in the shaft 114, and the locking member 130 is a nut coupled with the threaded section. The distance between the rotor portion 112 and the receiving portion 116 is less than the width of the color filter unit 120 on the shaft 114, thus, the locking member 130 can fix the color filter unit 120 to the rotor portion 112 by advancing the locking member 130 (i.e., screwing the nut) along the shaft 114 and toward the rotor portion 112 to push/hold the color filter unit 120 against the rotor portion 112. The elastic member 140 of this embodiment is interposed between the color filter unit 120 and the locking member 130.

The motor 110 is configured for driving the color filter unit 120 to rotate. In this embodiment, the rotor portion 112 is a rotating housing, and, in addition to the rotor portion 112 and the shaft 114, the motor 110 further includes electromagnetic members (not shown, e.g., ferromagnets or windings) received in the rotor portion 112 for driving the rotor portion 112 to rotate. The shaft 114 coaxially protrudes outward from the rotor portion 112 (i.e., the shaft 114 protrudes from the central portion of a surface 118 of the rotor portion 112 in contact with the color filter unit 120), thereby the rotor portion 112 and the shaft 114 are rotationally symmetric with respect to the shaft 114 and can be driven to rotate about the shaft 114 without eccentric effort.

The color filter 120 in accordance with this embodiment includes a carrier 124, e.g., metal ring, and a number of sector-shaped color filters 126 including, for example, R, G, and B color filters dedicated for exclusively transmitting a respective color light, and a clear filter for transmission of white light. The carrier 124 has an attachable surface 128, and the first through hole 122 is defined in the central portion of the attachable surface 128. The color filters 126 are radially attached to the attachable surface 128 using adhesive, e.g., hot-curable adhesive.

The elastic member 140 includes a disk-shaped solid body 142, and defines a second through hole 144 in the solid body 142 for insertably receiving the shaft 114. The solid body 142 is advantageously made of high polymer, such as silicone or rubber. The elastic member 140 is configured for: (1) preventing the rigid color filters 126, commonly including frangible glass, of the color filter unit 120 from being crushed by the rigid locking member 130; (2) absorbing vibration of the color filter unit 120; and (3) increasing the contact friction force applied to the color filter unit 120 to prevent the color filter unit 120 rotating relative to the shaft 114; in detail, the contact friction force of this embodiment is applied to the color filter unit 120 by the elastic member 140 instead of, conventionally, the locking member 130, since both the contact surface and the friction coefficient between the elastic member 140 and the color filter unit 120 are greater than those between the locking member 130 and the color filter unit 120 (the elastic member 140 subjected to compression tends to expand theist are of contact with the color filter unit 120), accordingly, the contact friction force in this embodiment is increased.

It is to be noted that the elastic member 140 is not limited to the above-mentioned embodiment, and alternative elastic members include:

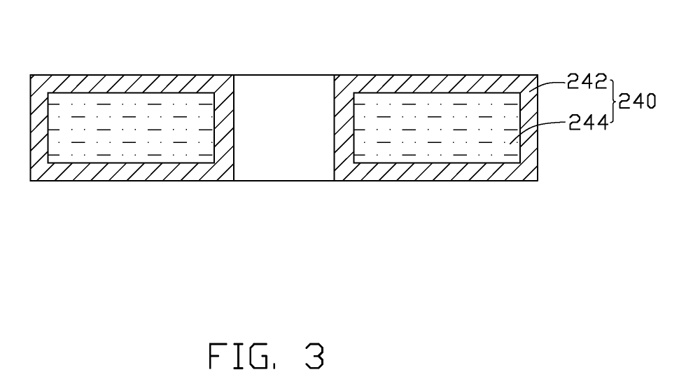

A first alternative elastic member 240, as shown in FIG. 3, includes a ring-shaped flexible encapsulation 241 and fill 242, such as, water or air, contained in the encapsulation 241.

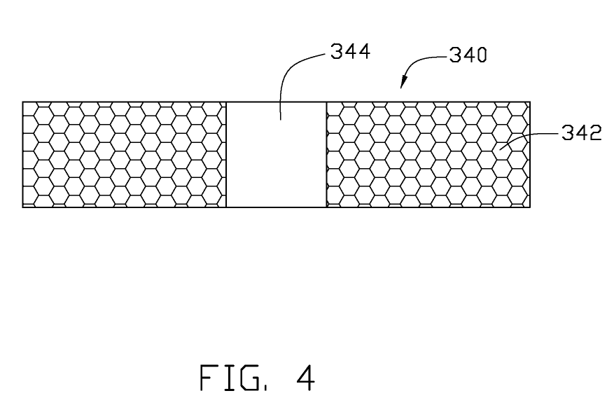

A second alternative elastic member 340, as illustrated in FIG. 4, includes a disk-shaped body 342 that defines a third through hole 344 for insertably receiving the shaft 114. The disk-shaped body 342 has honeycomb structure, and is beneficially made of, for example, plastic or rubber.

Understandably, the elastic members 240, 340 thus structured have a similar function as the elastic member 140.

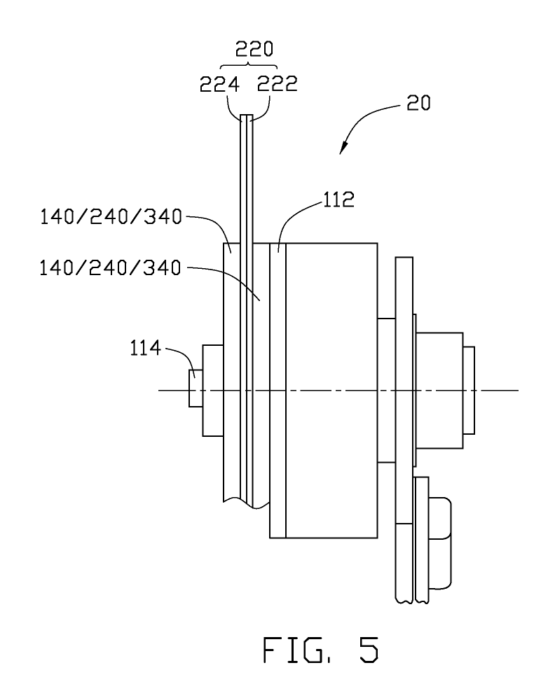

Referring to FIG. 5, a color wheel 20 of the second embodiment is essentially similar to the color wheel 10 of the first embodiment, as illustrated in FIG. 1, but further includes a more elastic member 140/240/340 interposed between the color filter unit 120 and the rotor portion 112.

Additionally, the color filter unit 220 of the color wheel 20 is different from the color filter unit 120, and includes a disk-shaped transparent substrate 222. One surface of the transparent substrate 222 is divided into a number of pie-shaped areas, each of which is coated with a unique color filter film 224, such as R, G, and B filter films respectively, each dedicated to exclusive transmission of a respective color light, or is uncoated for transmission of white light.

It is to be understood that elements from the embodiments, to the degree practical, could potentially be combined and/or interchanged. Further, where a mating and/or fitting match between parts is prescribed, it is to be understood that such a fit should permit sliding therebetween to allow reasonably easy assembly/disassembly yet should be tight enough to otherwise minimize any potential lateral movement/vibration therebetween.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A color wheel for use in a projection device comprising:
a motor including a rotor portion, the rotor portion protruding a shaft that defines a receiving portion therein;
a color filter unit defining a through hole therein for extension of the shaft therethrough;
a locking member slidably engaged with the receiving portion to fix the color filter to the rotor portion; and
an elastic member positioned at a position selected from a group of: between the rotor portion and the color filter unit, and between the color filter unit and the locking member.

2. The color wheel as claimed in claim 1, wherein the shaft coaxially protrudes outward from the rotor portion.

3. The color wheel as claimed in claim 1, wherein the receiving portion is defined at the distal end of the shaft.

4. The color wheel as claimed in claim 1, wherein the distance between the rotor portion and the receiving portion is less than the width of the color filter unit on the shaft.

5. The color wheel as claimed in claim 1, where in the receiving portion is a threaded section defined in the shaft, and the locking member is a nut coupled with the threaded section.

6. The color wheel as claimed in claim 1, wherein the color filter unit comprises a carrier and a plurality of sector-shaped color filters, the through hole being defined in the carrier, the plurality of sector-shaped color filters being radially attached to the carrier.

7. The color wheel as claimed in claim 1, wherein the color filter unit comprises a disk-shaped transparent substrate, the through hole being defined in the disk-shaped transparent substrate, one surface of the disk-shaped transparent substrate being divided into a plurality of pie-shaped areas, each of the plurality of pie-shaped areas being coated with a unique color filter film.

8. The color wheel as claimed in claim 1, the elastic member has a disk-shaped solid body, the disk-shaped solid body defining a through hole for extension of the shaft therethrough.

9. The color wheel as claimed in claim 8, wherein the elastic member is made of polymer.

10. The color wheel as claimed in claim 8, wherein the elastic member is comprised of a material selected from a group of silicone and rubber.

11. The color wheel as claimed in claim 1, wherein the elastic member comprises a ring-shaped flexible encapsulation and fill, the fill being contained in the encapsulation.

12. The color wheel as claimed in claim 11, wherein the fill is comprised of a material selected from a group of water and air.

13. The color wheel as claimed in claim 1, wherein the elastic member includes a disk-shaped body, the disk-shaped body has a honeycomb structure, and defines a through hole for extension of the shaft therethrough.

14. The color wheel as claimed in claim 13, wherein the disk-shaped body is comprised of a material selected from a group of plastic and rubber.
